(19) United States
(12) Patent Application Publication
(10) Pub. No.: US 2004/0193440 A1
(43) Pub. Date: Sep. 30, 2004

(54) Rent-a-car management apparatus and medium encoded with a rent-a-car management program

(76) Inventor: Noboru Mawatari, Aomori (JP)

Correspondence Address: SWIDLER BERLIN SHEREFF FRIEDMAN, LLP, 3000 K STREET, NW, BOX IP, WASHINGTON, DC, 20007, US

(21) Appl. No.: 10/777,038

(22) Filed: Feb. 13, 2004

(30) Foreign Application Priority Data
Mar. 26, 2003 (JP) 2003-085691

(51) Int. Cl. G06F 17/60

(52) U.S. Cl. 705/1

(57) ABSTRACT

A rent-a-car management apparatus includes a storage unit for storing rent-a-car identification information and return due-time-and-date information in association with each other. Information concerning a current position of a car which matches the rent-a-car identification number of a rent-a-car record read from the storage unit is obtained. Based on the information concerning the current position and information concerning a predetermined rent-a-car return place, a return traveling time required for the car to move to the predetermined rent-a-car return place is calculated. If the return traveling time is greater than or equal to the remaining time before the car is to be returned, return time limit information, route information, or extension-time input information for allowing the user to extend a rental period is sent to the rent-a-car terminal to inform the user at a suitable time that the return due time is approaching.

### BACKGROUND OF THE INVENTION

1. Field of the Invention

The present invention relates to a rent-a-car management apparatus for managing renting schedules of rental cars and computer-readable medium encoded with a rent-a-car management program being executed by a computer.

2. Description of the Related Art

In a typical rent-a-car system, a user goes to a renting place at a reserved time and date to rent a car, and returns it at a return time and date in a return place specified by a rent-a-car company. When the car is returned, the rent-a-car company allocates it for another user.

Japanese Unexamined Patent Application Publication No. 5-159143 discloses a technique, in order to increase the efficiency in allocating rental cars, for determining whether a rental car has been returned based on information indicating the position of a return place.

### SUMMARY OF THE INVENTION

Accordingly, it is an object of the present invention to provide a rent-a-car management program and a rent-a-car management apparatus for informing a user that a return due time and date for a rental car is approaching.

In order to achieve the above object, the present invention provides a rent-a-car management apparatus including a storage unit for storing rent-a-car identification information and return due-time-and-date information in association with each other. Information concerning a current position of a car which matches the rent-a-car identification information of a rent-a-car record read from the storage unit is obtained. Based on the information concerning the current position and information concerning a predetermined rent-a-car return place, a return traveling time required for the car to move to the predetermined rent-a-car return place is calculated. If the return traveling time is greater than or equal to the remaining time before the car is to be returned, return time limit information is sent to the rent-a-car terminal to inform the user that the return due time is approaching.

With this configuration, since the user is able to recognize a precise rent-a-car return time limit, he/she does not have to unnecessarily extend a rental period or return a car too early. The user does not have to input the route from a current position to a return place because he/she can be informed of the optimal route. The rent-a-car management apparatus can easily recognize that the user wishes to extend a rental period, and thus, it can smoothly perform car allocation for a next user.

### BRIEF DESCRIPTION OF THE DRAWINGS

FIG. 1 is a system block diagram;

FIG. 2 illustrates the configuration of a rent-a-car management database;

FIG. 3 is a flowchart illustrating rental request processing;

FIG. 4 illustrates an example of a rental request screen;

FIG. 5 illustrates another example of the rental request screen;

FIG. 6 illustrates still another example of the rental request screen;

FIG. 7 is a flowchart illustrating processing for displaying rent-a-car return information;

FIG. 8 is a flowchart illustrating rent-a-car extension/return selection processing;

FIG. 9 illustrates a return-instruction information screen;

FIG. 10 illustrates a rental-period extension information input screen;

FIG. 11 illustrates an extension-fee output screen;

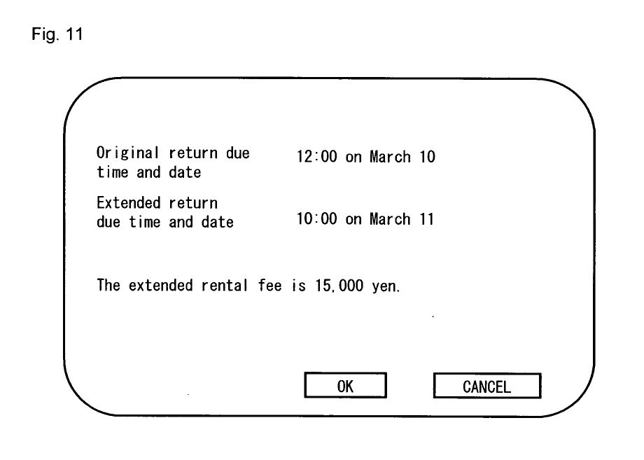

FIG. 12 is a flowchart illustrating rental-schedule setting processing; and

FIG. 13 is a flowchart illustrating car-allocation processing for a next user.

### DESCRIPTION OF THE PREFERRED EMBODIMENTS

The present invention is described in detail below with reference to the accompanying drawings through illustration of a preferred embodiment.

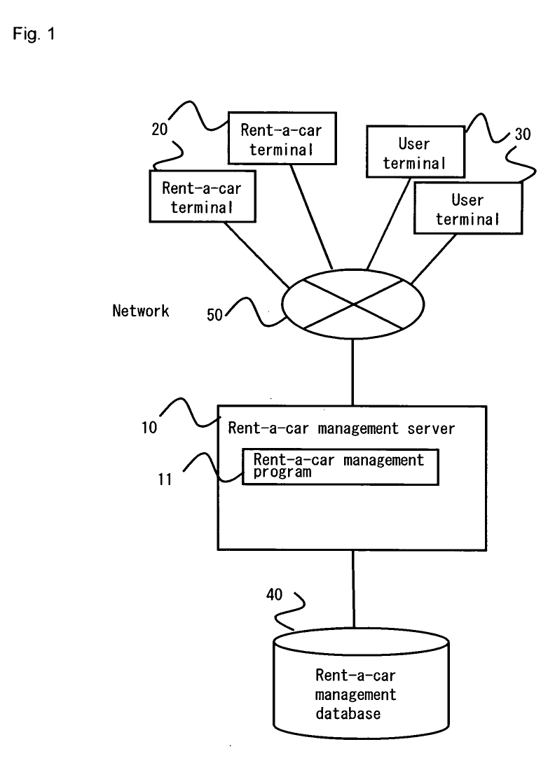

FIG. 1 is a block diagram illustrating a rent-a-car management system of the present invention. The rent-a-car management system shown in FIG. 1 includes a rent-a-car management server 10, rent-a-car terminals 20, user terminals 30, a rent-a-car management database 40, and a network 50.

The rent-a-car management server 10 includes a rent-a-car management program 11 for allowing a computer to execute management processing for rental cars. The rent-a-car management server 10 is connected to the rent-a-car terminals 20 and the user terminals 30 via the network 50, and is also connected to the rent-a-car management database 40. The rent-a-car management program 11 allows a computer to execute various functions, for example, a route calculating function of calculating an optimal route based on a current position and a target position, a traveling time calculating function of calculating a traveling time required for a rental car to travel to a target place, a rent-a-car reservation function, an extension-fee calculating function, a reservation management function, and a function of sending and receiving data to and from the rent-a-car terminals 20, the user terminals 30, and the rent-a-car management database 40.

The rent-a-car terminal 20, which is loaded in a rental car, has a function of displaying return instructions and making extension requests, and is wirelessly connected to the network 50. The rent-a-car terminal 20 also has a global positioning system (GPS) function of calculating a current position of the car. The user terminal 30, which is used by a user, sends and receives information indicating, for example, requesting, changing, or canceling a rental car to and from the rent-a-car management server 10 via the network 50. The rent-a-car management database 40 stores data of each rental car.

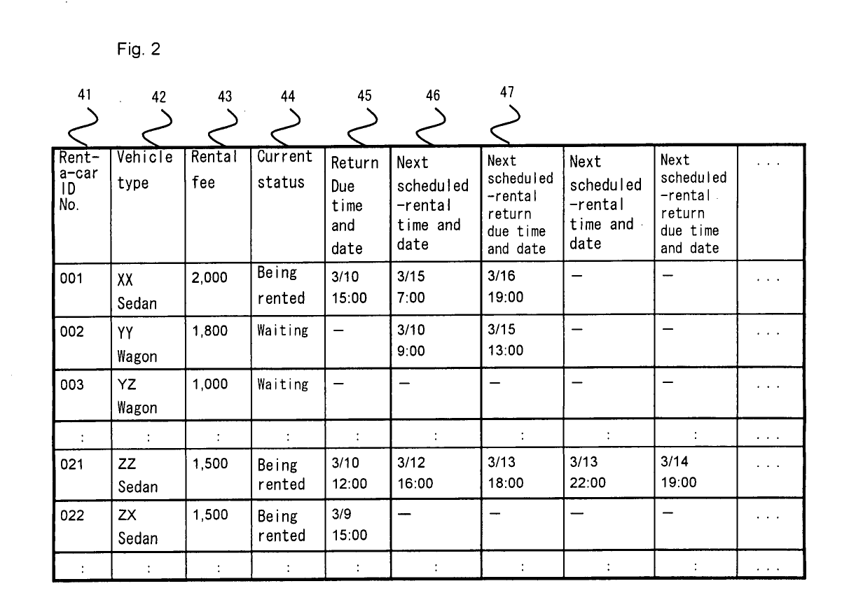

FIG. 2 illustrates the configuration of the rent-a-car management database 40. The rent-a-car management database 40 has items consisting of a rent-a-car ID number 41 assigned to each rental car, a vehicle type 42 of a rental car, a rental fee 43 per unit time, a current status 44 of a rental car, for example, “being rented” or “waiting”, a return due time and date 45 of a rental car which is now being rented, a next scheduled-rental time and date 46 indicating the time and date for a next rental, and a next scheduled-rental return due time and date 47 indicating the due time and date for a next rental. In the rent-a-car management database 40, the same number of items of the next scheduled-rental time and date 46 and the next scheduled-rental return due time and date 47 as the number of rental requests made by the user are contained in the corresponding record. Although it is not shown, a management database for rent-a-car users is also provided to manage the names of users who has made reservations to rent cars.

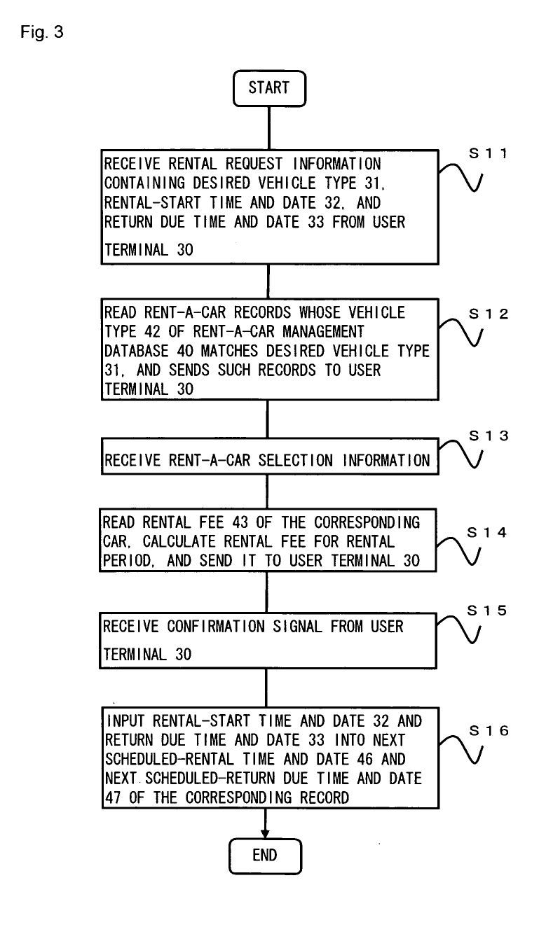

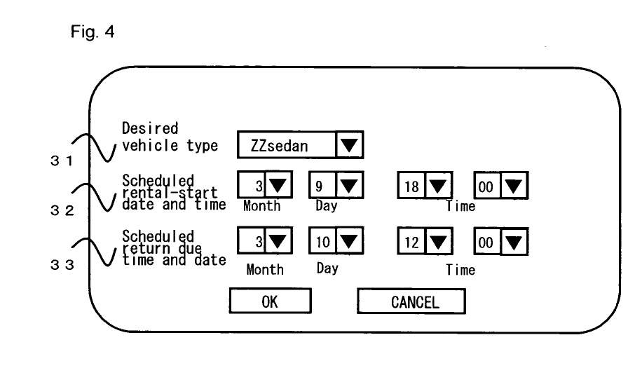

Rental request processing is now described with reference to the flowchart of FIG. 3. In step S11, the rent-a-car management program 11 sends information concerning a rental request screen to the user terminal 30. FIG. 4 illustrates an example of the rental request screen which is output to the screen of the user terminal 30. In the example shown in FIG. 4, a desired vehicle type 31, a scheduled rental-start date and time 32, and a scheduled return due time and date 33 are shown. When the user inputs desired rental information and presses an OK button, the rent-a-car management program 11 receives the rental request data.

In step S12, based on the desired vehicle type 31 input in step S11, the rent-a-car management program 11 reads rent-a-car records whose vehicle type 42 of the rent-a-car management database 40 matches the desired vehicle type 31, and sends such rent-a-car records to the user terminal 30.

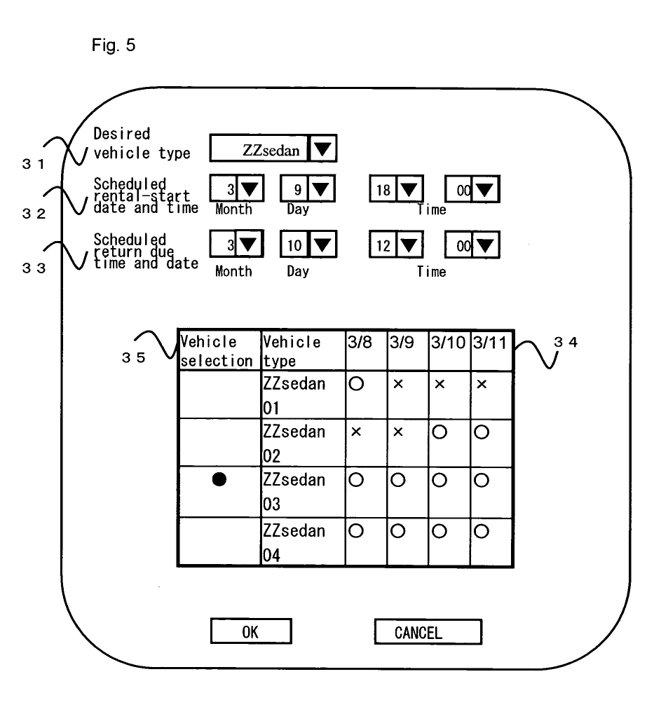

FIG. 5 illustrates another example of the rental request screen displayed on the user terminal 30. In the screen shown in FIG. 5, a rent-a-car list including items of a desired vehicle type 34 and a vehicle selection button 35 is indicated. When the user inputs vehicle selection information through the user terminal 30, in step S13, the rent-a-car management program 11 receives the vehicle selection information.

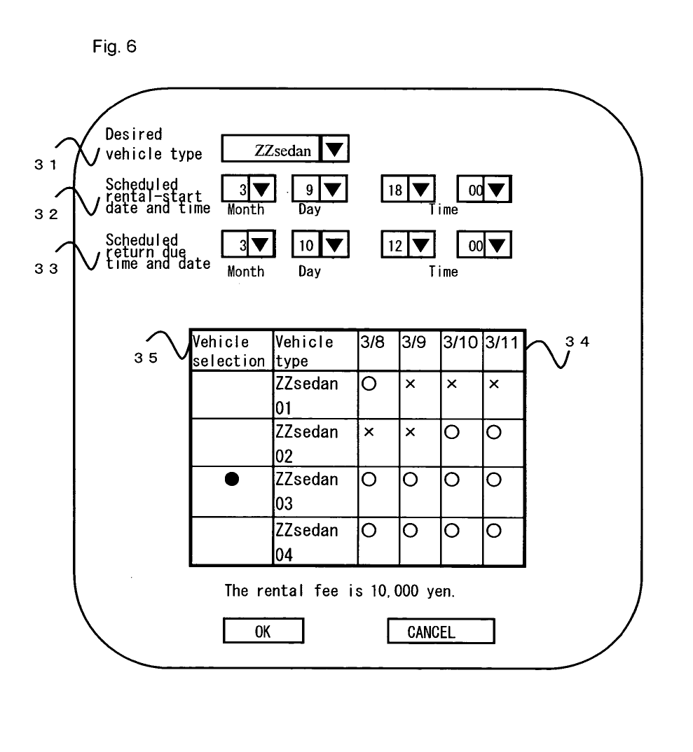

In step S14, the rent-a-car management program 11 reads the rental fee 43 from the rent-a-car management database 40 for the vehicle selected in step S13, and calculates a rental fee based on rental period information determined from the scheduled return due time and date 33 and the scheduled rental-start time and date 32 input by the user and sends the calculated rental fee to the user terminal 30. FIG. 6 illustrates an example of the screen when the rental fee is indicated.

In step S15, when the user checks and determines the rental information displayed on the user terminal 30, the rent-a-car management program 11 receives a confirmation signal. In step S16, the rent-a-car management program 11 inputs the scheduled rental-start time and date 32 and the scheduled return due time and date 33 into the items of the next scheduled-rental time and date 46 and the next scheduled-rental return due time and date 47, respectively, of the corresponding record. The rental request processing is then completed. In this embodiment, when the user selects the desired vehicle type and presses the “OK” button on the screen in FIG. 5, the rental fee is displayed on the screen in FIG. 6. However, the rental fee may be displayed together with the desired vehicle type on the screen in FIG. 5.

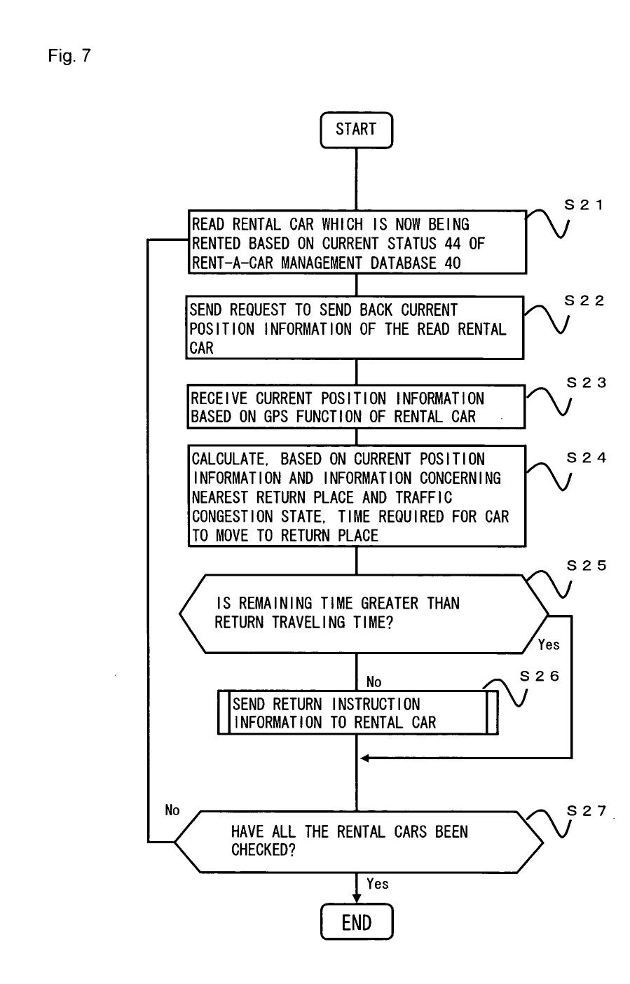

Processing for displaying rent-a-car return information for a car which is now being rented is described below with reference to the flowchart of FIG. 7. In this embodiment, processing for displaying rent-a-car return information is performed at regular intervals. In step S21, the rent-a-car management program 11 refers to the current status 44 of the rent-a-car management database 40 and reads a rent-a-car record which is now being rented. Then, in step S22, the rent-a-car management program 11 sends, based on the rent-a-car ID number 41 of the record read in step S22, a request to send back information concerning the current position of the rent-a-car.

Upon receiving the request from the rent-a-car management program 11, the rent-a-car terminal 20 of the car calculates a current position by using the GPS function, and sends the current position information to the rent-a-car management program 11. In step S23, the rent-a-car management program 11 receives the current position information of the car from the rent-a-car terminal 20. In step S24, the rent-a-car management program 11 calculates a time required for the rent-a-car to travel to the nearest return place based on the current position information received in step S23, and the information concerning the nearest return place, the traffic congestion state, etc.

In step S25, the rent-a-car management program 11 compares the return traveling time required for the rent-a-car to travel to the return place calculated in step S24 with a remaining time determined from the difference between the return due time and date 45 and the current time, and determines whether the remaining time is greater than the return traveling time. If the outcome of step S25 is YES, i.e., if there is a time allowance before the due time, the process proceeds to step S27. If it is determined in step S25 that the return traveling time is greater than or equal to the remaining time, i.e., if the user seems to be late for the return due time and date 45 unless he/she moves to the return place immediately, the process proceeds to step S26.

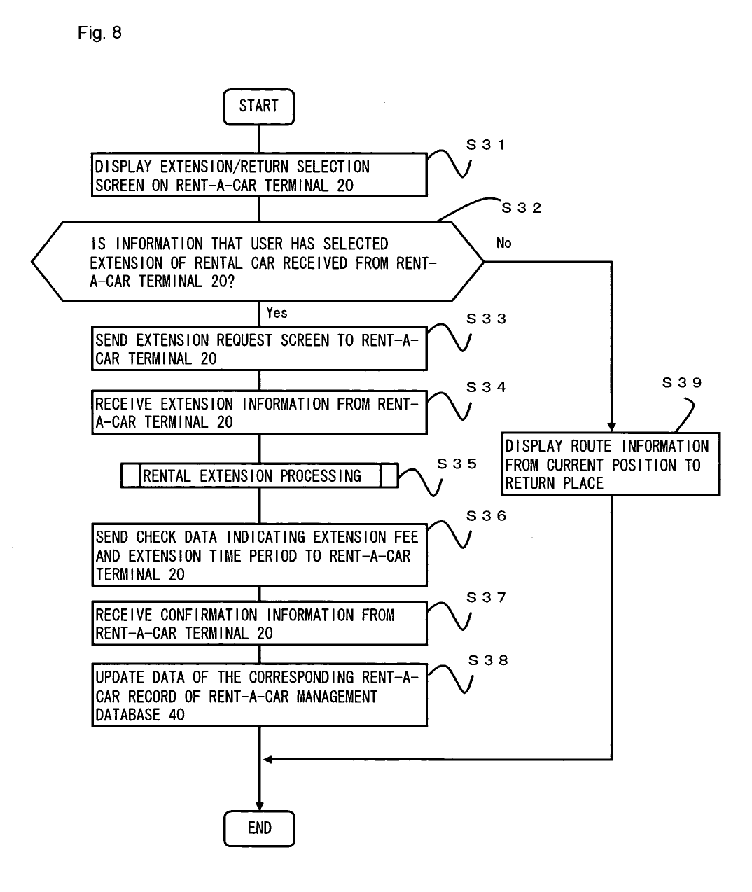

In step S26, the rent-a-car management program 11 sends information concerning a return-instruction screen to the rent-a-car terminal 20. Rent-a-car extension/return selection processing is discussed below with reference to the flowchart of FIG. 8. In step S31, the rent-a-car management program 11 sends information concerning an extension/return selection screen to the rent-a-car terminal 20 to instruct the user to select whether the user wishes to return the rent-a-car or extend the rental period.

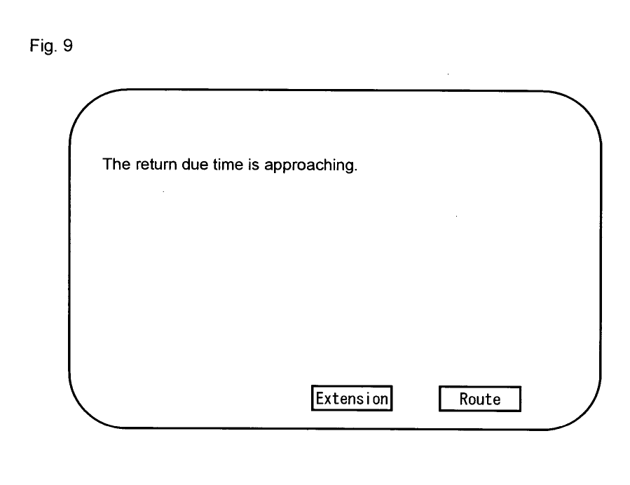

An example of the extension/return selection screen displayed on the rent-a-car terminal 20 is shown in FIG. 9. In the example in FIG. 9, a message indicating that the return due time is approaching is indicated, and also, the user is able to select whether he/she wishes to extend the rental period or display the route information. The user determines whether the user wishes to return the car or extend the rental period from the extension/return selection screen displayed in step S31. If the user has selected the extension of the rental period in step S32, the process proceeds to step S33 in which the rent-a-car management program 11 performs rental-period extension processing. If the user has selected the returning of the rent-a-car in step S32, the process proceeds to step S39 in which information indicating the route from the current position to the return place is sent to the rent-a-car terminal 20.

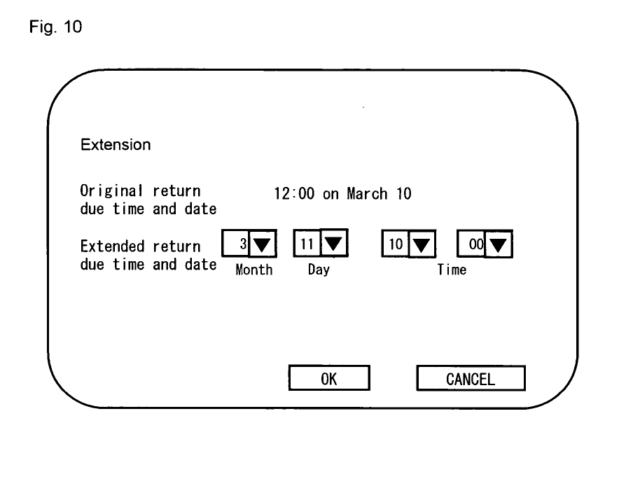

In step S33, the rent-a-car management program 11 sends information concerning a rental-period extension information input screen to the rent-a-car terminal 20. An example of the rental-period extension information input screen is shown in FIG. 10. On the rent-a-car terminal 20, the original return due time and date 45 is indicated, and an item for inputting an extended return due time and date is provided. When the user inputs extension information into the rent-a-car terminal 20, the rent-a-car management program 11 receives the extension information in step S34. Then, in step S35, the rent-a-car management program 11 performs rental extension processing based on the received extension information.

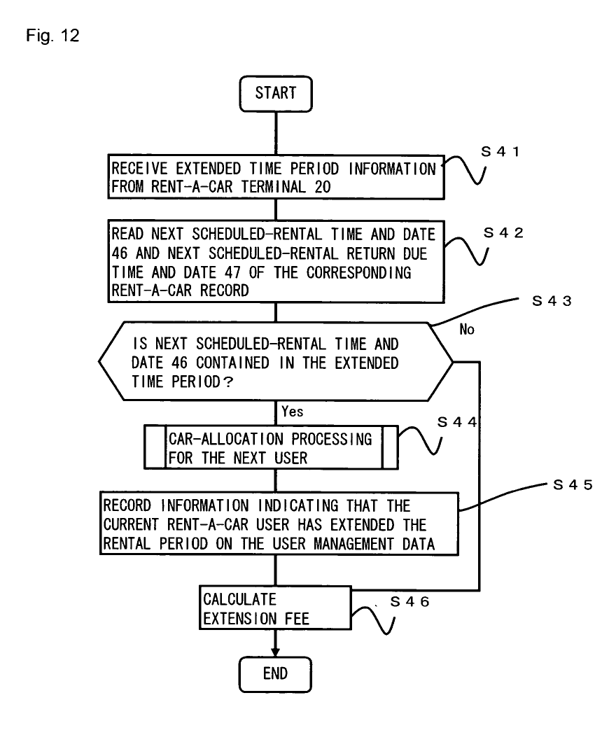

Details of the rental extension processing in step S35 are as follows. Rental-schedule setting processing is indicated by the flowchart of FIG. 12. In step S41, the rent-a-car management program 11 receives the extended time period information. Then, in step S42, the rent-a-car management program 11 reads the next scheduled-rental time and date 46 and the next scheduled-rental return due time and date 47 of the corresponding rent-a-car record from the rent-a-car management database 40. The rent-a-car management program 11 then determines in step S43 whether the next scheduled-rental time and date 46 is contained in the extended time period received from the user in step S41, that is, whether another user is to rent the corresponding car. If the outcome of step S43 is NO, an extension fee is calculated in step S46. If the rent-a-car management program 11 determines in step S43 that another user is to rent the corresponding car, car-allocation processing is performed for the next user in step S44.

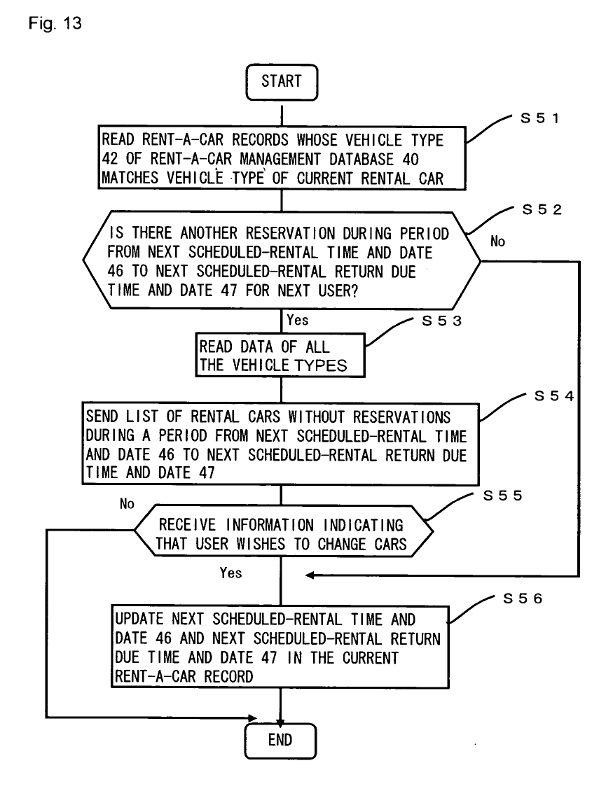

Details of the car-allocation processing for the next user are given below with reference to the flowchart of FIG. 13. In step S51, the rent-a-car management program 11 reads all the rent-a-car records which match the vehicle type of the current rent-a-car based on the vehicle type 42 of the rent-a-car management database 40.

The rent-a-car management program 11 determines in step S52 for all the rent-a-car records read in step S51 whether a reservation has been made during the rental time period from the next scheduled-rental time and date 46 to the next scheduled-rental return due time and date 47 for the next user. If the rent-a-car management program 11 determines in step S52 that there is no reservation during the above rental time period for the next user, it means that it is possible to change cars with the same vehicle type for the next user. Then, a car-change screen is output to the terminal of the next user, and in step S56, the next scheduled-rental time and date 46 and the next scheduled-rental return due time and date 47 for the next user are changed.

If the rent-a-car management program 11 determines in step S52 that reservations have been made in all the records of the same vehicle type, the process proceeds to step S53. In step S53, the rent-a-car management program 11 reads all the vehicle types of the rent-a-car management database 40. Then, in step S54, the rent-a-car management program 11 sends a list of rental cars without reservations in the rental time period of the next user to the user terminal 30.

The user checks the received rent-a-car list on the user terminal 30 and inputs a determination as to whether the user wishes to change the cars. If the rent-a-car management program 11 receives an instruction to change the cars from the user terminal 20 in step S55, the process proceeds to step S56. In step S56, the rent-a-car management program 11 reads the next scheduled-rental time and date 46 and the next scheduled-rental return due time and date 47 of the current record, and updates the data in the record of the selected car. If the rent-a-car management program 11 receives a message indicating that the user does not wish to change the cars in step S55, it returns a response, for example, an offer to discount the rental fee or to introduce another rent-a-car company to the user, though it is not shown.

In step S45 of FIG. 12, the rent-a-car management program 11 records information indicating that the current rent-a-car user has extended the rental period on the user management data, though it is not shown. This information is used for giving a warning that the user has extended the rental period when the same user reserves a rental car.

In step S46, the extension fee is calculated. In this case, the rental fee 43 is read from the rent-a-car management database 40, and based on the extension time period received in step S41, the product of the rental fee 43 and the extension time period is calculated. When the rental period is extended, an extra fee may be added, or the rate of the extra fee may further be increased if a next user is waiting.

In step S36 of FIG. 8, the rent-a-car management program 11 sends check data indicating the extension fee and the extension time period calculated in the rental extension processing in step S35 to the rent-a-car terminal 20. In step S37, the rent-a-car management program 11 receives confirmation information indicating that the user has checked and determined the data displayed on the rent-a-car terminal 20.

Then, in step S38, the rent-a-car management program 11 updates the return due time and date 45 of the corresponding rent-a-car record of the rent-a-car management database 40 based on the extension information from the user.

The rent-a-car management program then determines in step S27 whether the items of the current status 44 of all the rent-a-car records in the rent-a-car management database 40 have been checked. If the result of step S27 is NO, the process returns to step S21 for checking the current status 44 of the subsequent record. If all the rent-a-car records have been checked, the process is suspended until another display instruction is given.

Hardware forming the rent-a-car management server 10 includes a central processing unit (CPU), a read only memory (ROM), a random access memory (RAM), a hard disk drive (HDD), a hard disk (HD), a flexible disk drive (FDD), a flexible disk (FD), which is an example of detachable recording media, a display unit, and an interface (I/F). The CPU executes the rent-a-car management program 11. The ROM stores programs, for example, a boot program. The HDD controls the reading/writing of data from/into the HD under the control of the CPU. The HD stores data under the control of the HDD.

The FDD controls the reading/writing of data from/into the FD under the control of the CPU. The FD stores data under the control of the FDD or allows an information processing apparatus to read data stored in the FDD. The detachable recording media includes, not only the FD, but also a CD-ROM (CD-R or CD-RW), a magneto-optical disk (MO), a digital versatile disk (DVD), and a memory card. The display unit, for example, a cathode ray tube (CRT), a thin-film transistor (TFT) liquid crystal display, or a plasma display, displays a cursor, icons, tool boxes, and also displays windows for data, for example, documents, images, and function information.

The CPU executes the rent-a-car management program 11 stored in the ROM, RAM, HD, or FD so as to implement the functions of the rent-a-car management program 11. Part of various data and data tables to be stored in the rent-a-car management database 40 can be generated or erased in or from the RAM, which is used as a work area, when necessary.

The I/F is connected to a network, for example, a local area network (LAN) or the Internet, via a communication line, and is connected to another information processing apparatus (for example, a server) via the network. The I/F, for example, a modem, which serves as an interface between the network and the elements of the rent-a-car management server 10, controls the input/output of data into/from another server or information terminal.

In the above-described hardware configuration, because of a higher performance of CPU, strict restrictions, for example, which element executes which function, are no longer imposed, and the arrangement of the elements is not a limitation to execute the program.

What is claimed is:

1. A computer-readable medium encoded with a computer program for managing rent-a-car when executed by computer, said computer program comprising the steps of:
reading rent-a-car record from a storage unit which stores a rent-a-car identification number and in association with the time of the return schedule as the rent-a-car record;
obtaining present position information of the rental car corresponding to the rental car identification number in the rental car record;
calculating return travel time required for a rent-a-car to travel to the return place, based on the a predetermined rent-a-car return position information and the present position information of the rental car;
calculating remaining time until return schedule time from the present time; and
sending return time limit information to the rent-a-car terminal, when the remaining time becomes a predetermined amount with respect to said return travel time.

2. A computer-readable medium encoded with a computer program according to claim 1, wherein said predetermined amount is such that the remaining time minus said return travel time is equal to a predetermined allowance time.

3. A computer-readable medium encoded with a computer program according to claim 1, wherein said predetermined amount is such that said remaining time is equal to said return travel time.

4. A computer-readable medium encoded with a computer program according to claim 1, the step of sending return time limit information to the rent-a-car terminal further comprising the steps of:
sending the judgment item information on whether the rental period is to be extended to the rent-a-car terminal; and
calculating the course information to the return place based on the present position information and return position information of the rental car and sending the course information to the rent-a-car terminal when the information that extension of the rental period is not requested is received.

5. A computer-readable medium encoded with a computer program according to claim 1, the step of sending return time limit information to the rent-a-car terminal further comprising the steps of:
sending the judgment item information on whether the rental period is to be extended to the rent-a-car terminal;
sending the information of the item for inputting extended time when the information that extension of the rental period is requested is received; and
processing the rental extension for the rental car based on the extended time information received from the rent-a-car terminal.

6. A computer-readable medium encoded with a computer program according to claim 5, the step of processing the rental extension for the rental car further comprising the steps of:
reading next reservation information for the current rental car from the storage unit when the information that extension of the rental period is requested is received; and
sending the screen information for type-of-a-car change to a subscriber's terminal when there is next reservation.

7. A rent-a-car managing apparatus, comprising:
a storage unit which stores a rent-a-car identification number and the time of the return scheduled day, and was made to memorize as a rent-a-car record;
a means for reading rent-a-car record from a storage unit which stores a rent-a-car identification number and in association with the time of the return schedule as the rent-a-car record;
a means for obtaining present position information of the rental car corresponding to the rental car identification number in the rental car record;
a means for calculating return travel time required for a rental car to travel to the return place, based on the predetermined rent-a-car return position information and the present position information of the rental car;
a means for calculating remaining time until return schedule time from the present time; and
a means for sending return time limit information to the rent-a-car terminal, when the remaining time becomes a predetermined amount with respect to said return travel time.

8. A rent-a-car managing apparatus according to claim 7, wherein said predetermined amount is such that the remaining time minus said return travel time is equal to a predetermined allowance time.

9. A rent-a-car managing apparatus according to claim 7, wherein said predetermined amount is such that said remaining time is equal to said return travel time.

10. A rent-a-car managing apparatus according to claim 7, the means for sending return time limit information to the rent-a-car terminal further comprising:
a means for sending the judgment item information on whether the rental period is to be extended to the rent-a-car terminal; and
a means for calculating the course information to the return place based on the present position information and return position information of the rental car and sending the course information to the rent-a-car terminal when the information that extension of the rental period is not requested is received.

11. A rent-a-car managing apparatus according to claim 7, the means for sending return term information to the rent-a-car terminal further comprising:
a means for sending the judgment item information on whether the rental period is to be extended to the rent-a-car terminal;
a means for sending the information of the item for inputting extended time when the information that extension of the rental period is requested is received; and
a means for processing the rental extension for the rental car based on the extended time information received from the rent-a-car terminal.

12. A rent-a-car managing apparatus according to claim 11, the means for processing the rental extension for the rental car further comprising:
a storage unit on which next reservation information for the rental car was stored;
a means for reading next reservation information for the current rental car from the storage unit when the information that extension of the rental period is requested is received; and
a means for sending the screen information for type-of-a-car change to a subscriber's terminal when there is next reservation.
